(19) United States
(12) Patent Application Publication
(10) Pub. No.: US 2025/0080264 A1
(43) Pub. Date: Mar. 6, 2025

(54) METHOD AND APPARATUS FOR PRIVATE LINE EMULATION IN A PACKET-SWITCHED NETWORK

(71) Applicants: Walid Wakim, Plainfield, IL (US); Ashwin Gumaste, Santa Clara, CA (US)

(72) Inventors: Walid Wakim, Plainfield, IL (US); Ashwin Gumaste, Santa Clara, CA (US)

(21) Appl. No.: 18/818,586

(22) Filed: Aug. 28, 2024

Related U.S. Application Data
(60) Provisional application No. 63/535,061, filed on Aug. 28, 2023.

(51) Int. Cl. H04J 14/02; H04B 10/27

(52) U.S. Cl. CPC H04J 14/0227; H04B 10/27

(57) ABSTRACT

The present invention provides new and innovation solutions for packet line emulation over packet-switched networks.

### RELATED APPLICATION

This application is related to and claims priority to U.S. Provisional Patent Application No. 63/535,061, “Method and Apparatus for Private Line Emulation in a Packet-Switched Network,” filed Aug. 28, 2023, which is incorporated by reference herein.

### FIELD OF THE DISCLOSURE

The present invention relates to the fields of packet-switched network(s) and packet-switched network environment(s) (hereinafter, individually and collectively, “PSN”), private-line emulation (hereinafter, “PLE”), and client/transport devices, client/transport transmissions, client/transport networks and client/transport networking (hereinafter, for simplicity, “transport networking”) including without limitation optical transport networking (hereinafter OTN).

### BACKGROUND

PLE is, generally speaking, an existing communication networking construct known to those skilled in the pertinent art. As discussed herein, PLE can be an alternative to transport networking for delivering comparable services.

OTN for example offers high-speed circuit-switched systems that can provide end-to-end transport of bit streams of variable line rate across a transport network. OTN line rates match that of SONET/SDH and beyond, starting for example from ODU0 or about 1.25 Gb/s, OTU2 or about 11 Gb/s and thereafter OTU4 or about 110 Gb/s, with further concatenation of line rates to create larger pipes termed as OTU4c. The main value advantage of OTN has been the resilient, deterministic switching and forwarding infrastructure that offers reliable end-to-end communication through a transport network. Traditional forms of OTN switching equipment require precision timing as the basic OTN protocol is based on a bit interleaving mechanism, which is efficient multiplexing of multiple lower speed signals to obtain a clock-common higher speed signal. OTN is sometimes viewed as a relatively expensive technology relative to alternative network technologies, due at least in part to such a timing requirement in conjunction with specific line-rates that require further framing.

In contrast to the heavy protocol-dependent OTN transport technology, another paradigm is that of the packetized IP transport, where IP routers switch variable length packets in frames between ports based for example on a control plane federated/learned switching construct. While IP has emerged as a default mechanism for transport of services, especially for data-centric as well as video services which together have dominated much of the growth of the Internet, transport networking such as OTN for example has seen growth in the domain of leased lines for specific higher-end services, such as financial services, enterprise connectivity and enterprise VPNs, and others. Though the number of OTN lines has not grown at the same rate as IP traffic, it is observed that the OTN bandwidth continues to grow due to the net requirement of OTN lines by enterprises and specialized operations.

To this end, service providers often face a dichotomy of building a separate infrastructure for transport networking services from that which is built for IP services. Due to the voluminous increase in IP traffic (as compared to transport networking services such as OTN, for example), routers today are routinely built with forwarding planes in the 6+ Tb/s region, with interfaces at 100 Gb/s through to 800 Gb/s, and 1200 Gb/s and 1600 Gb/s pluggables on the horizon. In comparison, transport networking technology hasn't kept this same pace, and the fastest known forwarding plane is of the order of 1-2 Tb/s and is often considered to be prohibitively expensive compared to its IP counterpart.

IP routing infrastructure, by contrast, has commoditized somewhat, even at Tb/s capacities, and is abundantly available with relatively mature optics. Moreover, IPoDWDM (IP over Dense Wavelength Division Multiplexing) technologies and super-fast router data planes for example in the packet-switched network domain contribute to the cost effectiveness. Routing fabrics today typically use 5 nm technology to create extremely fast, efficient, and by implication, deterministic data planes. Modern VoQ-based architectures in conjunction with ultra dense node process for creating the fabric has led to fabrics that today are much more deterministic than in the past, when the fabrics were often inhibited by probabilistic delays. In view of these advancements, vendors have been investigating the use of routers to provision transport networking service, such as for example but without limitation OTN circuit services, in what is known in the industry as private line emulation (PLE). Indeed, for example in recent years the IETF has been working to establish a private line emulation standard.

### BRIEF DESCRIPTION OF THE DRAWINGS

The accompanying drawings, which are incorporated in and constitute a part of this specification, illustrate one or more example embodiments described herein and, together with the description, describe these implementations. The drawings are not intended to be drawn to scale, and certain features and certain views of the figures for example may be shown exaggerated, and/or otherwise not-to-scale, and/or in schematic form, in the interest of clarity and conciseness. Not every component may be labeled in every drawing. Like reference numerals in the figures may represent and refer to the same or similar element or function, even though such elements or functions may be non-identical from one figure or example embodiment to another figure or example embodiment. In the drawings:

FIG. 1 is a prior art PLE Reference Model figure.

FIG. 2A schematically illustrates an example embodiment of the present invention, including a packet-switched network and adjacent transport network devices comprising transport network elements and/or line cards thereof.

FIG. 2B again schematically illustrates the example network build of FIG. 2A, but now more generally depicting the control over a packet edge node regardless as to the source of such control.

FIG. 3A is schematic illustration of an example network build including a packet-switched network and adjacent transport network devices comprising transport network elements and/or line cards thereof, in accordance with an example embodiment of the present invention.

FIG. 3B further schematically illustrates the example network build of FIG. 3A, configured to provide transport services over a packet-switched network using PLE in accordance with an example embodiment of the present invention.

FIG. 3C again schematically illustrates the example network build of FIG. 3A, but now more generally depicting the control over a packet edge node regardless as to the source of such control.

FIG. 4 is schematic diagram of an exemplary embodiment showing representative components of one or more systems and/or devices of FIGS. 2, 3A and 3B.

FIG. 5 illustrates an example of a representative API signaling flow, associated with one or more of the example embodiments shown in FIGS. 2 and 3, between a given one of the illustrated transport network devices comprising a line card and/or associated transport network element, on one hand, and a network controller, on the other hand, for purposes of provisioning transport services using PLE over packet-switched network to the respective other of the illustrated transport network devices comprising the other line card and/or associated transport network element.

FIG. 6 illustrates a more detailed example of a representative API signaling flow, associated with one or more of the example embodiments shown in FIGS. 2 and 3, between a given one of the illustrated transport network devices comprising a line card and/or associated transport network element, on one hand, and a network controller, on the other hand, for purposes of provisioning transport services using PLE over packet-switched network to the respective other of the illustrated transport network devices comprising the other line card and/or associated transport network element.

### DETAILED DESCRIPTION

The following detailed description of example embodiments and implementations refers to the accompanying drawings. The same reference numbers in different drawings may identify the same or similar elements.

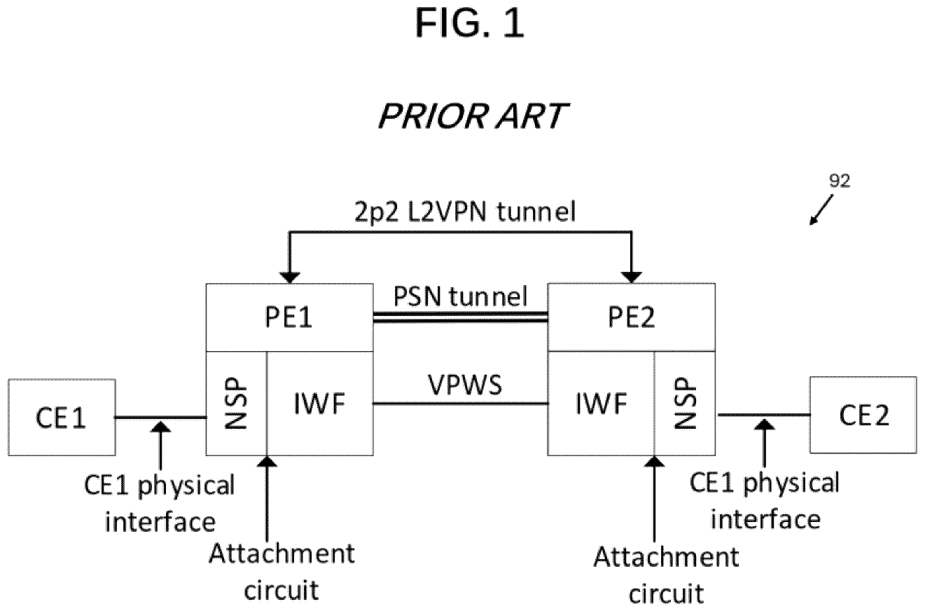

First, returning for a moment to standardization and/or other development activities to date in the industry in the area of private line emulation, FIG. 1 for example depicts prior art FIG. 1 from the IETF Network Working Group Internet Draft, “Private Line Emulation over Packet Switched Networks,” draft_ietf-pals-ple-04 (hereinafter, “Draft”), the entire contents of such Draft is hereby incorporated by reference. The Draft describes a method for encapsulating high-speed bit-streams as virtual private wire services (VPWS) over packet switched networks providing complete signal transport transparency.

The inventors of the present invention have observed that an underlying premise for such industry standardization and/or other development activities in the area of PLE is, generally speaking, a working assumption that a packet-switched network router is the principal component at the network edge which shall be responsible both to receive as a client a transport service, such as an OTN service for example, and to convert the received transport bit stream(s) to one or more packet streams, to be routed through the packet-switched network. As can be seen in FIG. 1, the NSP and IWF components and functions for example are described and shown by the Draft as components and functions of provider edge devices, which is understood to be packet edge routers of the packet switched network. The inventors have also recognized, however, that this assumption may impose certain limitations on the use of PLE in the provision of transport services.

For example, not fully addressed to date by such activities is whether or how a service provider might provision transport services using PLE under circumstances where for example routers of the contemplated packet-switched network do not by themselves provide and/or support PLE technologies, or under circumstances where for example routers of the contemplated packet-switched network together represent an assortment of routers manufactured by various router vendors whose respective PLE-supporting router technologies may be at least in part proprietary to that router vendor's routers or otherwise not readily compatible with another router vendor's PLE router technologies.

The present invention provides new and innovation solutions for PLE, as will be further described below in reference to various example embodiments of the present invention with reference to the above-identified figures.

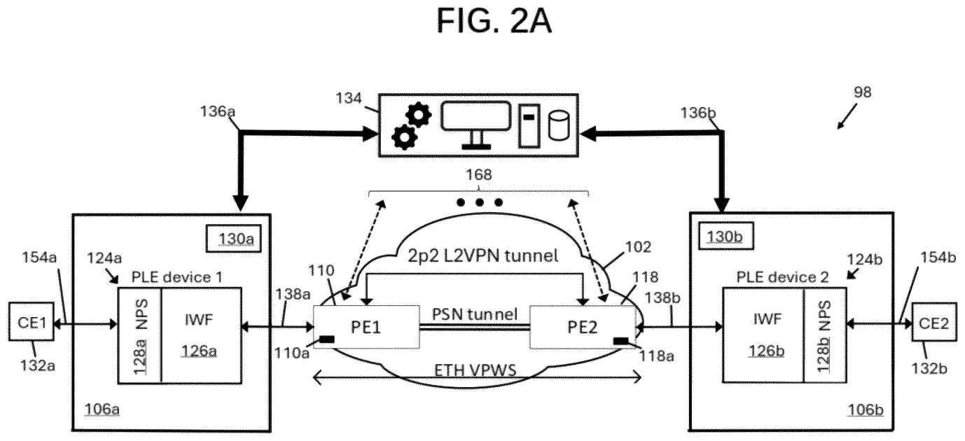

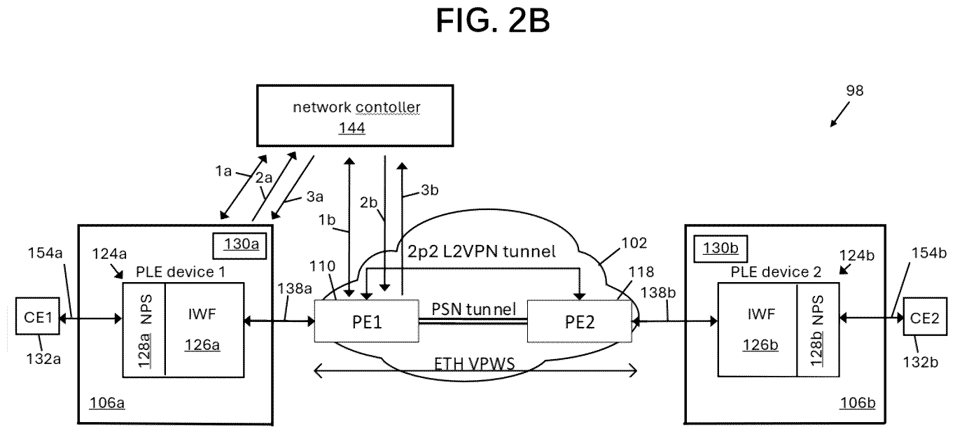

In particular, in at least one example embodiment of the present invention, pre-existing interworking components and functions, for example of the same sort contemplated and described by the IWF block of the Draft, for purposes that include packetizing, encapsulation and mapping of bit streams into private line emulation packets in a first direction, and inverse-packetizing, decapsulating and mapping private line emulation packets into reconstructed transport bit streams in a reverse direction, are deployed in a different manner. In particular, in such example embodiment(s) these interworking components and functions are for example implemented not as components and functions of packet edge routers of a packet-switched network as illustrated both in the Draft and in FIG. 1 herein, but rather as components and functions of transport network devices that are neither components nor functions of a packet-switched network. This is schematically illustrated for example by FIG. 2, wherein transport network (TN) devices within the depicted exemplary network build 98 include for example each line card 124a and 124b (which may be referred to herein in the singular as the line card 124 and in the plural as the line cards 124) with its interworking components and functions represented by interworking component and function (IWF) blocks 126a and 126b (which may be referred to herein in the singular as the IWF block 126 and in the plural as the IWF blocks 126), respectively, and by extension may be viewed as also including each transport network element 106a and 106b (which may be referred to herein in the singular as the network element 106 and in the plural as the network elements 106) that is illustrated as comprising a representative line card 124 with such IWF block 126.

These TN devices 106 and 124 may be deployed adjacent to the respective provider edge devices, or packet edge routers, 110 and 118 of the illustrated packet-switched network (PSN) 102, so as to interface with the packet-switched network. PSN 102 supports the illustrated 2p2 L2VPN tunnel that extends between packet edge routers, 110 and 118, and may include additional routers (not shown). Such interface may be for example either directly through an interface between the TN device 106/124 and a packet edge router 110/118 for example, or indirectly through an attachment circuit such as an Ethernet attachment circuit 138 for example, as is shown schematically for example in FIG. 2. Furthermore, the interface between TN device 106/124 and a packet edge router 110/118 may be for example physical, or it may be virtual.

In general, the network elements 106 of the example embodiments described herein each transmits and/or receives transport data traffic and control signals. Nonexclusive examples of implementations of a network element 106 include optical line terminals (OLTs), optical cross connects (OXCs), optical line amplifiers, optical add/drop multiplexer (OADMs), reconfigurable optical add/drop multiplexers (ROADMs), and/or OTN network disaggregation platforms.

One network element 106 for example may interconnect with one or more other network elements within the same transport network by way of optical fiber links (not shown). Each one of the two illustrated network elements 106 in this exemplary implementation may be a stand-alone network element 106, or instead belong to its own respective transport network to which such network element 106 further interconnects (not shown) to the exclusion of the other network element 106, or instead belong to the same transport network as the other network element 106. Network elements 106 may each communicatively interface to a respective customer edge 132.

As referenced above, each of the two illustrated network elements 106, or one or more components thereof such as for example a line card or pluggable, is configured in this exemplary embodiment to interface and communicate with a respective packet edge router (e.g., PE1 and PE2, in FIGS. 2) 110 and 118 of packet-switched network 102. In particular, network element 106a, or one or more components thereof, is configured to interface and communicate with the packet edge router 110, and network element 106b, or one or more components thereof, is configured to interface and communicate with the packet edge router 118.

In relation to the example embodiment schematically depicted by FIG. 2, the NSP block 128 is responsible for performing operations on the native transport services data, such as for example in the example of OTN services, any forward error correction (FEC), and/or terminating an OTUk layer for OTN, and/or multi-lane processing, to name a few example native service functions of the sort that are also described in the Draft in relation to the Draft's NSP block depicted in the Draft's FIG. 1. The NSP block 128 may be responsible for performing other native service functions of the sort described in the Draft in relation to the NSP components and functions contemplated by the Draft.

Generally speaking, packetization, encapsulation and/or mapping of one or more PSN-bound client/transport (for simplicity, hereinafter “transport”) services bit stream(s) into packets associated with at least one PSN private line emulation service is, for simplicity, individually and collectively herein referred to as “PSN-bound interworking,” regardless of the particular transport services protocol(s) involved and regardless of the particular protocol(s) used to establish and/or facilitate the private line emulation service. Also for simplicity, inverse packetization, decapsulation and/or mapping of one or more customer/client (for simplicity, hereinafter “client”) edge-bound packets (hereinafter, “CE-bound packets”) associated with at least one PSN private line emulation service into one or more transport services bit stream(s) is, for simplicity, individually and collectively herein referred to as “CE-bound interworking,” regardless of the particular transport services protocol(s) involved and regardless of the particular protocol(s) used to establish and/or facilitate the private line emulation service.

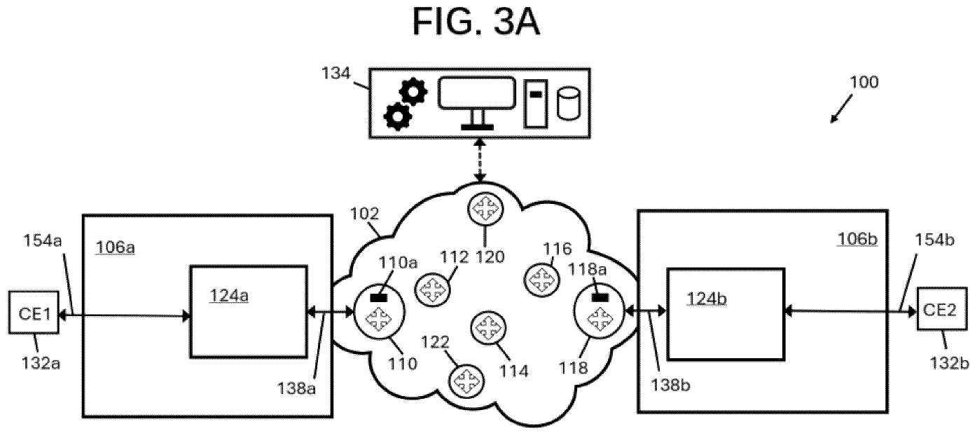

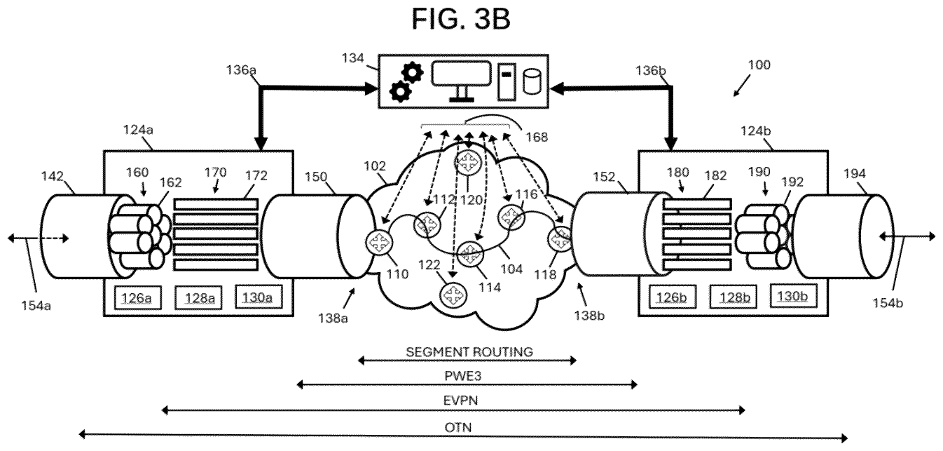

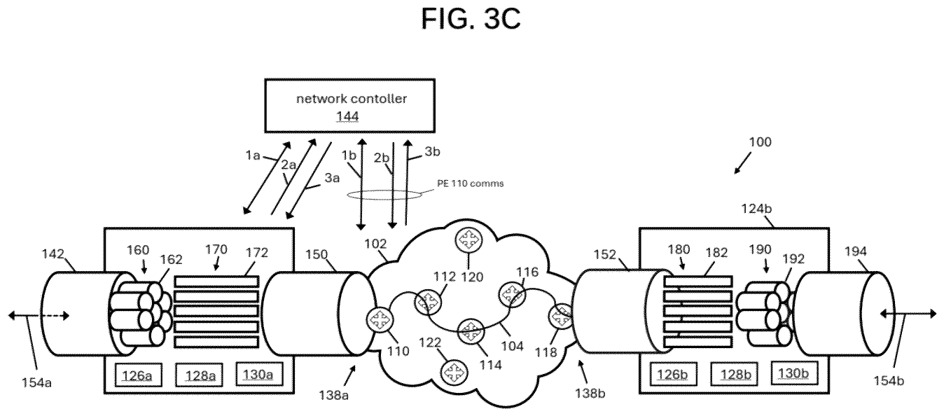

Returning to FIG. 2, the IWF block 126 in each network element 106a and 106b (more specifically, each line card 124a and 124b (PLE device 1 and PLE device 2) thereof) of FIG. 2 is responsible for performing PSN-bound interworking so as to generate a payload for communication via a virtual private wire service (VPWS) that is carried by the packet-switched network 102 via a PSN tunnel. To this end, one or more transport services bit stream(s) (such as OTN, for example) are received at client edge (CE) interface 154, PSN-bound interworked by IWF block 126, and provided as packetized data to the packet-switched network 102 through interface 138. Each of the CE interface 154 and PSN interface 138 may be a physical or virtual interface. The PSN interface 138 is configured to directly or indirectly interface with the packet-switched network 102, such as for example via a direct connection to an interface of a packet edge router 110, 118, or for example indirectly through an attachment circuit such as an Ethernet attachment circuit (not shown in FIG. 3 distinct from PSN interface 138) for example.

In the reverse direction, namely in the direction of customer edge CE 132 (CE1 132a and/or CE2 132b, respectively) for example, the IWF block 126 in each network element 106a and 106b is also responsible for performing CE-bound interworking. To this end, in the respective network element 106a or 106b (more specifically, each line card 124a and 124b (PLE device 1 and PLE device 2) thereof), PLE packetized data is received from packet-switched network 102 at the PSN interface 138 (e.g., whether or not through an intervening attachment circuit of the sort described above), CE-bound interworked by IWF block 126, and provided as one or more transport bit stream(s) to CE interface 154. Such transport bit stream(s) in turn are available to customer edge 132a (CE1) or customer edge 132b (CE2), respectively. The IWF block 126 may be responsible for performing other interworking functions of the sort described in the Draft in relation to the IWF components and functions contemplated by the Draft.

Similarly, referring now to the example embodiment schematically depicted by FIGS. 3A and 3B, shown therein is an exemplary network build 100, again comprising packet-switched network 102 and adjacent transport network elements 106a and 106b. As is the case in FIG. 2, in FIG. 3 transport network elements 106a and 106b exist outside the domain of the packet-switched network 102, for example in a transport networking environment, but nevertheless respectively interface, whether physically, virtually, directly, or indirectly (e.g., through an Ethernet attachment circuit, not shown in FIG. 3) for example, with or to the packet-switched network 102, and in particular, edge routers 110 and 118 of the packet-switched network 102.

The packet-switched network 102, as shown in FIGS. 3A and 3B, is further depicted as having a plurality of additional routers 112, 114, 116, 120 and 122, some of which may be additional packet edge routers (PEs) while others may be packet core routers (Ps). Although seven representative routers 110, 112, 114, 116, 118, 120 and 122 are schematically depicted in FIGS. 3A and 3B for the purposes of illustration, it will be understood that a given packet-switched network may comprise fewer or additional routers. Similarly, although two representative network elements 106 are schematically depicted in FIG. 3 for the purposes of illustration, it will be understood that a different number of network elements could be deployed. For clarity, the foregoing applies equally in relation to the example embodiment of FIG. 2.

Each network element 106a and 106b shown in FIG. 3A (and more specifically, each line card 124a and 124b thereof shown in FIGS. 3A and 3B) is responsible for performing PSN-bound interworking so as to generate a payload for communication via a PLE service established in the packet-switched network 102, enabled at least in part for example by pseudowire 104 that is established in the PSN 102 so as to extend between packet edge routers 110 and 118 through routers 112, 114 and 116. To this end, one or more transport bit stream(s) are received at CE interface 154, PSN-bound interworked by line card 124, and provided as packetized data to the packet-switched network 102 through interface 138. Each of the CE interface 154 and PSN interface 138 may be a physical or virtual interface. The PSN interface 138 is configured to directly or indirectly interface with the packet-switched network 102, such as for example via a direct connection to an interface of a packet edge router 110, 118, or for example indirectly through an attachment circuit such as an Ethernet attachment circuit (not shown in FIG. 3 distinct from PSN interface 138) for example.

In the reverse direction, namely in the direction of customer edge CE 132 (CE1 132a and/or CE2 132b, respectively, illustrated in FIG. 3A) for example, the line card 124 in each network element 106a and 106b is also responsible for performing CE-bound interworking. To this end, in the respective network element 106a or 106b (more specifically, each line card 124a and 124b thereof), packetized data from a PLE service (i.e., pseudowire (PW)) that is established in the packet-switched network 102 is received from packet-switched network 102 at the PSN interface 138 (e.g., whether or not through an intervening attachment circuit of the sort described above), CE-bound interworked by the line card 124, and provided as one or more transport bit stream(s) to CE interface 154. Such transport bit stream(s) in turn are available to customer edge 132a (CE1) or customer edge 132b (CE2), respectively. The line card 124 may be responsible for performing other functions, including without limitation interworking functions and/or native service functions for example.

Also depicted schematically for example in FIG. 3 are OTU4 142, ODU plurality 160, representative ODUw 162, pseudowire (PW) plurality 170, representative PWx 172, ESI 150, ESI 152, pseudowire (PW) plurality 180, representative PWy 182, ODU plurality 190, representative ODUz 182, OTU4 142, IWF blocks 126a and 126b, and NPS blocks 128a and 128b.

One or more embodiments of the present invention, including for example the example embodiments shown in FIGS. 2 and 3, contemplate a signaling framework that facilitates the use of a packet-switched network to create a PLE domain. In the case of the embodiments of FIGS. 2 and 3 for example, the PLE domain is enabled using technologies known to those skilled in the art that may be selected for example from a group consisting of at least Ethernet, IP, MPLS, L2VPN tunneling, VPWS, EVPN, PWE3, Ethernet segment identifier (ESI), pseudowire, and segment routing. Also contemplated among these example embodiments is a signaling framework between for example the TN device (e.g., line card 124/network element 106) responsible for PSN-bound interworking, on one hand, and a network controller 144—whether that network controller 144 comprises for example the network management system or controller 134 (hereinafter for simply, controller 134), and/or one or more router control planes and/or other controller(s) (at least some of which are represented for example and for simplicity by illustrated controllers 110a and 118a of PEs 110 and 118, respectively, although other routers of the PSN 102 may also comprise similar controllers)—on the other hand, for purposes of establishing a private line emulation service in a packet-switched network to carry one or more transport bit stream(s) that have been PSN-bound interworked by the TN device. That signaling framework may be also used to tear down, configure, administer, monitor and/or manage the private line emulation service. The signaling framework may also support PLE routing learning, as further described below for example.

Although the following description is provided herein with principal reference to the illustrated example embodiment of FIG. 3 and the particular details shown therein, those skilled in the art will, with the benefit of this disclosure, appreciate that a significant portion of this description may also apply in the context of an example embodiment that is consistent with the illustrated and described example embodiment depicted in FIG. 2.

The packet-switched network 102 of FIG. 3 consists of routers of at least two types—edge routers (PE) and core routers (P). Such routers include for example at least edge routers 110 and 118, and one or more core routers among the remaining illustrated routers 112, 114, 116, 120 and 122. The enabling packet-switched network forwarding protocol in this particular embodiment is segment routing, although other embodiments may use alternative forwarding protocols, such as for example the embodiment illustrated by FIG. 2, which is MPLS-based. The packet-switched network 102 in the example embodiment of FIG. 3 may comprise routers having integer multiple of 100 Gb/s line rate interfaces, such as for example line rates of 100 Gb/s, 200 Gb/s, 400 Gb/s, and 800 Gb/s. One or more pseudowires (PWs) of the sort described for example in RFC 3981 (the entire contents of RFC 3981 is hereby incorporated by reference) can be set up by a network controller 144 so as to establish private line emulation service supported by the packet-switched network 102 (e.g., along the illustrated path 104 for example).

The P routers along the path 104 are configured to treat the PW as a high priority service allocating enough resources (such as queue management, QoS values, buffer space) that facilitate express passing of the PW packets from the source to the destination. PWs for private line emulation services exist in this example embodiment at a higher QoS value than other services. Moreover, a given PW is preferably given a bandwidth (BW) allocation that is the same across all links along the given path of the given PW (such as for example, all links along path 104 for the associated example PW described herein). That said, it remains possible that at least one or more links along the given PW path have a bandwidth that is not the same as the bandwidth of the PW path's ingress/egress link. In such a case, the controller (e.g., network controller 144) may provision the PW such that it splits along the path into multiple smaller PWs. Such splitting and/or merging of PWs along the path is generally referred to as inverse multiplexing.

The illustrated network controller 144 of FIG. 3B is responsible for controlling at least a portion if not the entirety of the packet-switched network 102, including specifically the routers 110, 112, 114, 116, 118, 120 and 122 of the packet-switched network 102, and may also be configured to provide control to one or more network components outside the domain of the packet-switched network 102. Among the controls that the network controller 144 provides with respect to the routers 110, 112, 114, 116, 118, 120 and 122 of the packet-switched network 102 is for example network management system-based and/or router control plane functions for establishing, tearing down, management and efficient running of pseudowires within the packet-switched network 102.

In the example embodiment depicted in FIG. 3, the network controller 144 is provided to at least the packet edge routers 110 and 118 (FIGS. 2 and 3A, 3B), as well as depicted packet routers 112, 114, 116, 120 and 122. This may include a data control network that may include the communication channels 168. In this way, the network controller 144 may communicate with each of the routers 110, 112, 114, 116, 118, 120 and 122, and may transmit signaling and/or other information to, and/or receive signaling and/or other information from, the routers 110, 112, 114, 116, 118, 120 and 122.

As noted above, the pertinent network controller 144 may be integrated into one or more of the routers 110, 112, 114, 116, 118, 120 and 122, whether in whole or in part, such as for example controllers 110a and 118a. In some implementations, the network controller 144 may be a remote network element, and/or may be partially or completely network-based or cloud-based, and/or may or may not be located in a single physical location.

In the case of controller 134, the communication channels 168 may permit bi-directional communication of information between the controller 134 and/or the routers 110, 112, 114, 116, 118, 120 and 122 of the packet-switched network 102, preferably as part of a data control network (DCN). The communication channels 168 of this example embodiment may utilize one or more of a variety of network protocols, known to those skilled in the art, to permit bi-directional interface and/or communication of data and/or information between the controller 134 or other network controller 144 and the routers 110, 112, 114, 116, 118, 120 and 122. Moreover, the communication channels 168 of this example embodiment may be a network connection. For example, in some embodiments, the communication channels 168, and/or any alternative data control network construct that my apply instead or in addition, may be a version of an Internet network (e.g., exist in a TCP/IP-based network). In one implementation, the communication channels 168 and data control network construct are the Internet. It should be noted, however, that the communication channels 168 and other data control network constructs may be almost any type of network and may be implemented, for example and without limitation, as the World Wide Web (or Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, or combinations thereof. Moreover, the communication channels 168 may be physical and/or virtual channels.

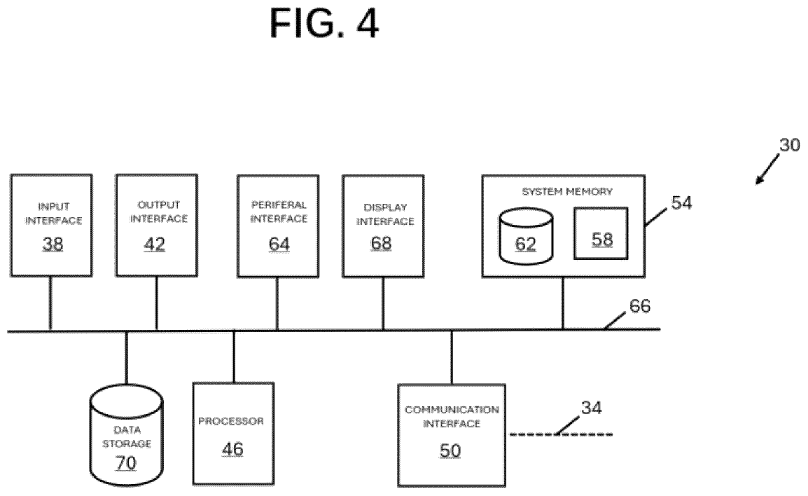

Referring briefly now to FIG. 4, shown therein is a diagram of example components of one or more devices and/or systems of FIGS. 2 and 3, although certain embodiments of such devices and/or systems may not implement some or all of the example components shown in the diagram. In FIG. 4, a system 30 may include implementations such as for example (and, by implication, without limitation) a pluggable computer housed in a network chassis, a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, a controller, and/or other forms of processing systems and systems that process. In some embodiments, the system 30 may include for example one or more input devices and/or interfaces 38 (for simplicity hereinafter “input interface 38”), one or more output devices and/or interfaces 42 (for simplicity hereinafter “output interface 42”), one or more processors 46 (for simplicity hereinafter “processor 46”), one or more communication devices and/or interfaces 50 (for simplicity hereinafter “communication interface 50”) capable of interfacing with a communication channel 34, one or more peripheral devices and/or interfaces 64 (for simplicity hereinafter “peripheral interface 64”), one or more display devices and/or interfaces 68 (for simplicity hereinafter “display interface 68”), one or more data storage devices and/or interfaces 70 (for simplicity hereinafter “data storage 70”), one or more non-transitory processor-readable medium (hereinafter “system memory 54”) storing processor-executable code and/or software application(s) 58, which may include for example a web browser capable of accessing a website and/or code or applications for communicating information over a wireless or wired network (e.g., the communication channel 34), and/or the like, and/or a database 62. The input interface 38, the output interface 42, the processor 46, the communication interface 50, peripheral interface 64, display interface 68, data storage 70, system memory 54, and/or database 62, may be connected via a path 66 such as a data bus that permits communication among the components of the system 30.

In some implementations, the processor 46 may comprise one or more processors 46 working together, or independently, to read and/or execute processor executable code and/or data, such as stored in the system memory 54 and/or data storage 70. The processor 46 may be capable of creating, manipulating, retrieving, altering, and/or storing data structures into the system memory 54, data storage 70 and/or database 62. Each element of the system 30 may be partially or completely network-based or cloud-based, and may or may not be located in a single physical location.

As used herein, the term “processor” refers to a device such as for example a single- or multi-core processor, a special purpose processor, a conventional processor, a Graphics Processing Unit (GPU), a digital signal processor (DSP), a central processing unit (CPU), a microprocessor, a multi-core processor, a microprocessor in association with a DSP core, a controller, a microcontroller, an application specific integrated circuit (ASIC), a Field Programmable Gate Array (FPGA) circuit, any other type of integrated circuit (IC), a system-on-a-chip (SOC), a state machine, or a similar type of device. Processor 46 may be or include any one or several of these devices, including combinations thereof.

The processor 46 may be capable of communicating with the system memory 54, data storage 70 and/or database 62, via the path 66 (e.g., data bus). The processor 46 may be capable of communicating with one or more of the input interface 38, output interface 42, peripheral interface 64, and display interface 68, also via the path 66. The processor 46 may be capable of interfacing and/or facilitating communications to, from and/or between the components of the system 30. Moreover, the processor 46, as a component of a given device and/or system shown in FIGS. 2 and 3, may be further capable of interfacing and/or facilitating communications to, from and/or between itself and/or other of the devices and/or systems shown in FIGS. 2 and 3, for example via the communication interface 50 and the communication channel 34 illustrated in the representative schematic of FIG. 4. For example, the processor 46 may be capable of communicating via the communication channel 34 by exchanging signals (e.g., analog, digital, optical, and/or the like) via one or more ports (e.g., physical or virtual ports) using a network protocol to provide information to another device and/or system.

The system memory 54 may be or include for example a device such as a Random Access Memory (RAM), Dynamic RAM (D-RAM), Static RAM (S-RAM), other RAM or a flash memory. Further, system memory 54 may be for example a device using a computer-readable medium. The system memory 54 may be or include for example a hard disk, a magneto-optical medium, a solid-state drive (SSD), an optical medium such as a compact disk (CD) read only memory (ROM) (CD-ROM), a digital versatile disk (DVDs), or Blu-Ray disc (BD), or other type of device for electronic data storage. Further, the system memory 54 may be for example a device using a computer-readable medium. As used herein, the term “computer-readable medium” refers to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

The system memory 54 may for example store a software application 58 that, when executed by the processor 46, causes the system 30 to perform an action such as communicate with, or control, one or more components of the system 30, another device and/or system outside of the system 30, and/or the communication channel 34.

In some implementations, the system memory 54 for example may have a data store that may store data such as network element version information, firmware version information, sensor data, system data, metrics, logs, tracing, and the like in a raw format as well as transformed data that may be used for tasks such as reporting, visualization, analytics, signal routing, power loading operations and/or coordination, etc. The data store may include for example structured data from relational databases, semi-structured data, unstructured data, time-series data, and binary data. The data store for example may be a database, a remote accessible storage, or a distributed filesystem. The data store may be data storage 70, for example, or another data store. In some embodiments, the data store may be a component of an enterprise network.

In some implementations, the system memory 54 may be located in the same physical location as the system 30, and/or one or more system memory 54 may be located remotely from the system 30. For example, the system memory 54 may be located remotely from the system 30 and communicate with the processor 46 via the communication channel 34. Additionally, when more than one system memory 54 is used, a first system memory may be located in the same physical location as the processor 46, and additional system memory may be located in a location physically remote from the processor 46. Additionally, the system memory 54 may be implemented as a “cloud” non-transitory processor-readable storage memory (i.e., one or more of the system memories 54 may be partially or completely based on or accessed using the communication channel 34).

In one implementation, the database 62 may be a time-series database, a relational database or a non-relational database. Examples of such databases comprise, DB2®, Microsoft® Access, Microsoft® SQL Server, Oracle®, mySQL, PostgreSQL, MongoDB, Apache Cassandra, InfluxDB, Prometheus, Redis, Elasticsearch, TimescaleDB, and/or the like. It should be understood that these examples have been provided for the purposes of illustration only and should not be construed as limiting the presently disclosed inventive concepts. The database 62 can be centralized or distributed across multiple systems.

The input interface 38 may be capable for example of receiving information input for example from the user, another computer or other system, and/or the processor 46, and transmitting such information to other components of the system 30 and/or the communication channel 34. The output interface 42 may be capable for example of outputting information in a form perceivable by the user (as also does the display interface 68), another device, another system, and/or the processor 46. It is to be understood that in some exemplary embodiments, the input interface 38 and the output interface 42 may be implemented as a single device and/or interface. It is also to be further understood that the term “user,” as hereafter used herein, is not limited to a human being, and may comprise for example a website, a computer, whether virtual or otherwise, a server, a processor, a network interface, a user terminal, a system, and/or combinations thereof, and/or the like, for example.

The communication interface 50 may be, for example, a communications port, a wired transceiver, a wireless transceiver, and/or a network card. The communication interface 50 may be capable for example of interfacing with a data communication network (DCN) for example, The communication interface 50 may be capable for example of communicating using protocols and/or technologies such as SDN technology, wide area network (WAN) technology, SD-WAN technology, Ethernet, Gigabit Ethernet, fiber optics, microwave, xDSL (Digital Subscriber Line), Institute of Electrical and Electronics Engineers (IEEE) 802.11 technology, Wireless Local Area Network (WLAN) technology, wireless cellular technology, or any other appropriate or applicable protocols and/or technologies.

The peripheral interface 64 may operate for example using a technology such as Universal Serial Bus (USB), PS/2, Bluetooth, infrared, serial port, parallel port, FireWire and/or other appropriate technology. The peripheral interface 64 may, for example, receive input data from an input device such as a keyboard, a keypad, a mouse, a trackball, a touch screen, a touch pad, a stylus pad, a detector, a microphone, a biometric scanner, or other device. The peripheral interface 64 may provide the input data to the processor 46. The peripheral interface 64 may also, for example, provide output data, received from the processor 46, to output devices such as a speaker, a printer, a haptic feedback device, one or more lights, or other device. Further, an input driver may communicate with the processor 46, peripheral interface 64 and input devices, and permit the processor 46 to receive input from the input devices. In addition, an output driver may communicate with the processor 46, peripheral interface 64 and output devices, and permit the processor 46 to provide output to the output devices. One of ordinary skill in the art will understand that the input driver and the output driver may or may not be used.

The display interface 68 may be for example one or more display devices and/or interfaces configured to communicate data to a display device, such as for example a monitor or television display, a plasma display, a liquid crystal display (LCD), or a display based on a technology such as front or rear projection, light emitting diodes (LEDs), organic LEDs (OLEDs), or Digital Light Processing (DLP). The display interface 68 may operate using technology such as Video Graphics Array (VGA), Super VGA (S-VGA), Digital Visual Interface (DVI), High-Definition Multimedia Interface (HDMI), Super Extended Graphics Array (SXGA), Quad Extended Graphics Array (QXGA), or other appropriate technology. The display interface 68 may communicate display data from the processor 46 to a connected display device.

### PW/PLE Establishment

Returning now to the example embodiments shown in FIGS. 2 and 3, the TN device responsible for PSN-bound interworking of a given transport bit stream is also responsible for signaling to the network controller 144 a request that in turn establishes, within the packet-switched network 102 and pursuant to the control of network controller 144, one or more pseudowires (PW(s)) to support PLE service(s). Note once again that network controller 144, as shown for example in FIGS. 2B and 3C and described herein in relation to the disclosed example embodiments, generically represents control of PSN routers/network (via intervening controller(s), RMS, NMS, or via direct communication), whether such control is provided by for example a network management system, one or more router control planes, and/or other controller(s). Network controller 144 may additionally represent control of transport devices/network (via intervening controller(s), NMS, or via direct communication). Signaling between the given TN device 136 and the network controller 144, as well as between the PSN routers and the network controller 144, may occur for example across a data control network. Such data control network may include for example communication channel 136 between the given TN device 136 and the controller 134 (e.g., communication channel 136a for TN device 124a/106a), if for example network controller 144 comprises the controller 134. Regardless, in these embodiments it is the TN device 136, and not the packet edge router nor another element of the packet-switched network, that signals to the network controller 144 a request that in turn establishes, within the packet-switched network 102, one or more pseudowires (PW(s)) to support PLE service(s).

To establish a pseudowire in the example embodiments set forth herein, a service template or model is completed for example by a service manager (e.g., a provider or individual who seeks to establish, tear down, configure, administer, monitor and/or manage PWs/PLE services) or other user, wherein the completed template or model specifies information pertaining for example to the respective source and destination IPs of the applicable PE and TN devices, the possible MAC address(es) of the TN devices, and the desired bandwidth/granularity of the PLE service. In addition, the service manager or other user may also in this way specify additional constraints, such as for example the particular PW/PLE path to be followed in whole or in part, maximum allowable latency, cost of provisioning, packet-switched network nodes/elements to be avoided by and/or included in the PW/PLE path, maximum size of allowable packet, and/or jitter bound. The methodology of this particular example embodiment operates as follows:

### Step 1:

A client side of a PLE API 130 resident for example on TN device 106/124 (e.g., TN device 106a) pings a network controller 144 to which TN device 106/124 communicates PSN-bound packets (e.g., PE 110) and in turn establishes a control manifestation with the network controller 144. The network controller 144 may in one example embodiment support multi-tenant centralized control. In another example embodiment such control could be single tenant, employing a translation of a request from the service manager or other user to the network controller 144 to establish one or more PWs/PLEs.

The foregoing API 130 in this embodiment serves as an interface between the TN device 106/124 and the PE device (e.g., PE 110) as well as the network controller 144. API 130 as use thereof as described herein thereby more broadly distributes control over the packet-switched network, so as to allow the TN device 106/124 the opportunity to participate from outside the PSN 102 in establishing, tearing down, configuring, administering, monitoring and/or managing PWs/PLE services, via network controller 144, that operate within the PSN 102. The embodiment of FIG. 2 may similarly employ an API 130 (not shown in FIG. 2) for these same general purposes.

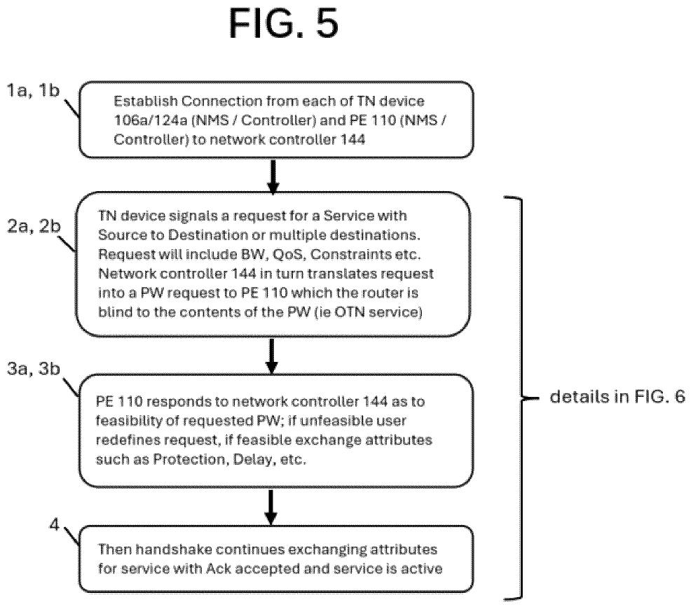

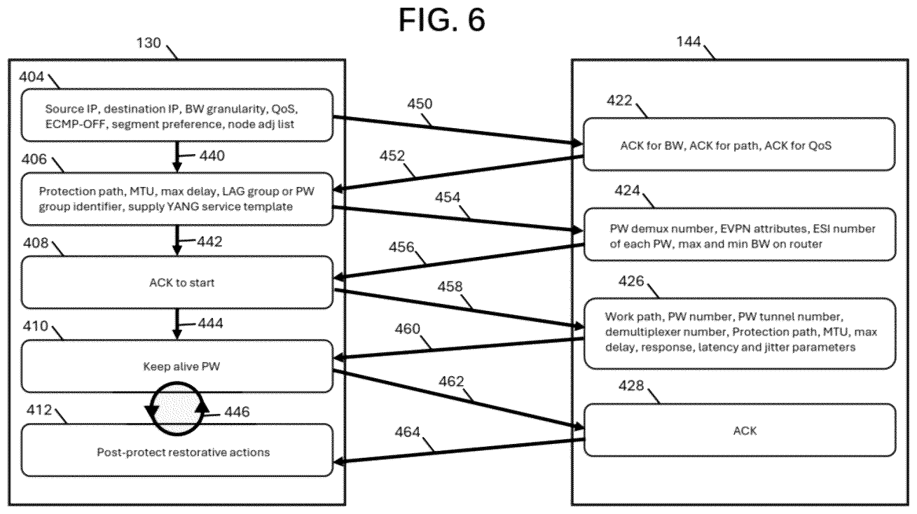

Example API schemas for the example embodiments of FIGS. 2 and 3 are illustrated in FIGS. 5 and 6. The API 130 of TN device 106/124 (e.g., TN device 106a/124a) provides for a user interface connection that is used for example by a service manager or other user, thus allowing one or more service templates or models to be loaded either manually or automatically through a software script. As mentioned above, these service templates or models, when completed for example by the service manager or other user, may help define various particulars of a requested PW/PLE service to be established in the PSN 102. The API 130 also provides for a controller connection that communicatively connects the TN device 106/124 (e.g., TN device 106a/124a) to a Network controller, such as for example router management system (RMS) of the PE (e.g., router management system (RMS) 110a of PE 110). In at least this example embodiment, this RMS 110a of PE 110 has complete view of the network of routers within the PSN 102, including for example paths, routes, pluggables, and interfaces in terms of provisioning and control. Although both PE 110 and PE 118 are illustrated in FIG. 3A as each comprising a RMS 110a and RMS 118a, respectively, it shall be understood that as many as up to all of the other routers 112, 114, 116, 120 and 122 in this example embodiment may each similarly comprise a RMS (not shown, for simplicity). Also for simplicity, FIG. 3B does not illustrate any RMS in any of the routers, although it shall be understood that FIG. 3B represents the same embodiment as FIG. 3A, including without limitation the same routers as shown in FIG. 3A.

### Step 2:

In response to appropriate input by the service manager or other user, the TN device 106/124 (e.g., TN device 106a/124a) signals a request to a controller, such as for example network controller 144, that the controller establish at least one pseudowire (PW) extending within the packet switched network between the first node and at least one destination node of the packet switched network. Such PLE service(s) may have destinations of different bandwidth/granularities.

### Step 3:

The API facilitates communication with the PSN as to a new PW service to be set up or established. The router does not have to have the capability to understand that the new service (PW) is a transport service; it is only required to understand for example the scope of the request as a PW of fixed bandwidth/granularity from a given source to one or more set of destinations.

### Step 4:

The router NMS/controller examines resources at its end, and communicates back on a go/no-go status whether a PW can be provisioned. The NMS/controller also responds with its parameters, constraints and requirements/capabilities.

### Step 5:

The service manager or other user can further tune the requirements of the PW to adjust to the constraints of the PSN by using traditional best-fit algorithms that work on individual demands.

### Step 6:

The NMS/controller signals back set up of the PW and the service manager or other user can now begin data transfer of transport data frames into bitstreams mapped on to Ethernet packets/IP packet.

### PW/PLE Tear-Down

Service manager or other user communicates through the API to the TN device and PE NMS/Controller via network controller 144 to tear down the PW. It does so only after the data is stopped at either end. An in-band mechanism for TN device control can facilitate such data stoppage. In one example embodiment, a flag can be used to indicate stoppage of data. In another example embodiment, one side can generate a pre-agreed sequence of bytes stuffed into Ethernet frames, that when read at the egress indicate to the egress that the PW is going to be torn down and hence to stop its PW data.

### Example Transport Network Device Types

In one or more example embodiments, there are at least two types of example transport network devices that are each nevertheless configured to perform both PSN-bound interworking and CE-bound interworking. A first of these two example transport network device types (for simplicity, hereinafter “first example TN device type”) is a 1:1 OTN-to-PW/PLE device that performs PSN-bound interworking on incoming OTN circuit bit stream(s) and performs CE-bound interworking on incoming PW(s). The first example TN device type provides for mapping of a given PW and PW control word to a given client-side OTN circuit bit stream. In the example embodiment of the present invention illustrated in FIG. 2, each of TN devices 106a/124a and 106b/124b may be of this first example TN device type for example, providing 1:1 mapping of PW(s) at each of the depicted ingress and egress points of the packet switched network 102.

The second of these two example transport network device types (for simplicity, hereinafter “second example TN device type”) is also an OTN-to-PW/PLE device that, like the first example TN device type, performs PSN-bound interworking on incoming OTN circuit bit stream(s) and performs CE-bound interworking on incoming PW(s), except that in the case of the second example TN device type, the TN device is essentially a NxM OTN-to-PW/PLE device that is capable of receiving at its CE interface up to a first plurality (N) of OTN tributaries or circuit bit streams, and in turn perform PSN-bound interworking on such incoming OTN circuit bit stream(s) so as to map the incoming OTN circuit bit streams to one or more PWs among a second plurality (M) of PWs available to the TN device via its PSN interface.

If for example it is assumed for the moment that each of TN devices 106a/124a and 106b/124b in the example embodiment illustrated in FIG. 3 is consistent with this second example TN device type, it should be noted that the API 130 (e.g., API 130a of TN device 106a/124a) preferably need not communicate to a controller (e.g., RMS 110a, controller 134, or more generically, network controller 144) to identify either the value of N or the particulars of the N-to-M mapping (OTN tributaries to PWs). Rather, the TN device 106a/124a (via API 130a) simply communicates data representing a request that M PWs be established in the PSN 102. Further, the TN device 106a/124a (via API 130a) may establish a unique identifier, such as for example an Ethernet Segment Identifier (ESI) that enables each of the outgoing virtual interfaces on the TN device to be uniquely identified. Such an ESI is as defined for example in EVPN RFC7932 (the entire contents of which is hereby incorporated by reference), and in that example consists of 10xoctets for identification purposes.

Those skilled in the art shall understand from the foregoing disclosure that a plurality of these second example TN device types are deployed such that each communicatively connects with one or more of the others among the plurality, across various PWs/PLE paths within the PSN, in turn may enable an inverse multiplexing function to be implemented within the PSN.

In yet another example embodiment, one TN device that is of this second example TN device type may be mapped to a plurality of PWs/PLEs that each lead to a different destination TN device among a plurality of TN devices that are of the first TN device type. In this embodiment, an incoming high-speed OTN tributary received by the one TN device may be effectively demultiplexed and distributed across the PSN to a plurality of respective lower-speed OTN tributary CE destinations.

### PSN as Virtual Switch

From the foregoing it will be understood that a given PSN (for example PSN 102 in at least certain of the above-described example embodiments) can be configured route each of a plurality of PWs/PLEs that ingress the given PSN (e.g., at PE 110, and any other similar PEs (not shown) of PSN 102 where PW(s) ingress the PSN 102) to one or more distinct points of PSN egress (e.g., at PE 118, and any other similar PEs (not shown) of PSN 102 where PW(s) egress the PSN 102). In this regard, the PSN behaves like a virtual switch, wherein for example one or more PWs each having a select line rate can be selectively established in the PSN to enable select routing, multiplexing, and/or demultiplexing of the one or more OTN bit streams that ingress the PSN and are carried across the PSN via the PW(s). Such select configurations for example may be determined automatically by a controller in whole or in part, and/or determined through at least certain input or other interaction supplied by a service manager or other user.

In at least certain example embodiments, such input or other interaction supplied by a service manager or other user may be enabled for example by the above-described API 130. Once the various desired PWs are established, the API 130 can define a preset service model, using for example a generator tool such as YANG or Openconfig. The established PWs can thereafter be monitored, for example based on requirements that define the SLA(s) of the end user(s). The service manager or other user for example can specify monitoring parameters, which can be defined and agreed-upon by the PSN through a YANG service model or an OpenConfig requirement, for example. Such monitoring parameters may include for example a periodic connectivity check, loop back and link trace messages, fault messages and messages that otherwise indicate abnormal and/or undesired behavior of the PWs.

### Multiple Line Rate(s)

Generally speaking, OTN contemplates various line rates, such as for example OTU2 at 10 Gb/s and OTU4 at 100 Gb/s with extra framing overhead (as high as 13% on top of the base line rate, for example). When a given OTN circuit or bit stream is PSN-bound interworked into a given PW as contemplated by the above-described embodiments of the present invention there is an increase in the amount of data that is to be transported across the PSN. More specifically, the bandwidth of the resulting PW is greater than the bandwidth of the associated OTN circuit. The intent of this increase in BW is to help maintain a latency profile among the stream of packets communicated along the PW. The excess BW of the PW, as compared to the OTN bit stream(s) that the PW carries, helps mitigate against an adverse latency impact to the packets along the PW caused by other competing flows at routers within the PSN. In one example embodiment, the PW bandwidth is selected to be as much as 20% more (i.e., a 20% spread percentage) than the base line rate of the OTN signal(s) carried by the PW.

A target spread percentage, or resulting PW bandwidth, can be determined at least in part for example using queuing theory estimations. A target spread percentage, or resulting PW bandwidth, instead or also may be determined at least in part for example based on a crank back signaling mechanism and/or protocol that for example enables the service manager or other user to employ latency feedback from the PW to determine an appropriate PW bandwidth. The afore-mentioned API may be used to facilitate communications relating to crank back signaling mechanisms and/or protocols.

In view of the foregoing, it will be understood that OTU2 signals can be, for example, multiplexed/muxed-up into 100GE PWs or mapped to multiple 10GE PWs. An OTU4 signal can be, for example, communicated either as a plurality of 10GE PWs or communicated as three PWs, 1×100GE PW and 2×10GE PWs, or communicated along a higher-rate PW such as a PW having 200GE or 400GE bandwidth.

In yet another example embodiment, PW bandwidth towards the edge of the PSN may be multiplexed further into the PSN, under circumstances where for example one or more PEs may not support a higher-speed PWs at the PSN edge. In this example scenario, a crank back signaling mechanism may be employed to assist in an effective selection of the PW bandwidth so as to optimize the latency for OTN transport through the PSN using PLE.

### Protection and Restoration

Protection and restoration can be realized according to the appropriate PSN protocols, using for example either MPLS fast reroute (FRR), preferably using local centralized restoration, or segment-routing-based protection and restoration. It is preferrable that the protection paths are both node- and edge-disjoint from the working paths. In the event that no such graph disjoint paths are found, it is preferrable that the paths be as disjoint as reasonably possible, and if not fully disjoint fully, then it is preferrable that those link(s) which are common are selected from among the available link(s) comprising or demonstrating the highest relative levels availability and/or reliability.

In one example embodiment, in-service monitoring TN device 106a/124a is performed, while in another example embodiment the PSN is instead responsible to conduct the monitoring, the results of which may be made available to the TN device 106a/124a for example as a subscription service.

In an example embodiment, IEEE802.1ag control messages are periodically sent in dual direction (both) and measured. A drop of three consecutive lag control messages for example, but without limitation, may be deemed to indicate that there is a detected abnormality, and in turn trigger corrective action. Preferably, however, in an effort to achieve trigger and complete corrective action within 50 ms of the abnormality detection, corrective action is preferably triggering upon an identified first loss of a CCM message. 50 ms restoration can be realized, for example, by maintaining two active PWs for a given OTN circuit bit stream and switching between these two active PWs when the monitoring scheme gives rise to a restoration-triggering event.

### PW/PLE Routing Learning

In at least one example embodiment the service manager or other user can, using the API, learn about the operation of the PSN by observing the latency and jitter profiles associated with the PWs. The service manager or other user may for example measure the jitter and/or latency characteristics, which in turn may be used to plot regression graphs for each of the PWs. Furthermore, the service manager or other user can, by using the API to ping each PSN router that is responsible for supporting one or more PWs, build a base understanding of which routers are, relatively speaking, more heavily loaded and which are more lightly loaded. The service manager or other user then may, for example, use a latency and/or jitter regression analysis to determine the relatively better, if not best, paths through the PSN. This sort of learning is achieved based on logistic regression and is Bayesian in nature. The key hyperparameters of this learning are edge weights (as latency values) and graph attributes (router locations).

Although the exemplary embodiments of the present disclosure are described above in detail with reference to the accompanying drawing(s), the present disclosure is not limited thereto and may be embodied in different forms and combinations apparent to those skilled in the art, based on the teachings hereof, without departing from the technical concept of the present disclosure. The exemplary embodiments of the present disclosure are provided for illustrative purposes only and are not intended to limit the technical concept of the present disclosure. Therefore, it should be understood that the above-described exemplary embodiments are illustrative in all aspects and do not limit the present disclosure.

Even though particular combinations of features are disclosed in the specification, these combinations are not intended to limit the disclosure. In fact, features may be combined in ways not specifically disclosed in the specification, as will be apparent to those skilled in the art based on the teachings hereof.

No element, act, or instruction used in the present disclosure should be construed as critical or essential to the invention unless explicitly described as such. Further, the phrase “based on” is intended to mean “based, at least in part, on” unless explicitly stated otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements, components and/or aspects of the embodiments herein. This is done merely for convenience and to give a general sense of the inventive concept. This description should be read to include one or more and the singular also includes the plural unless it is obvious that it is meant otherwise.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

What is claimed is:

1. A transport network device for communicating transport network data, comprising:
a first interface configured to receive transport network data;
a packet network interface configured to interface with a first node of a packet switched network;
at least one processor configured to enable the transport network device to:
signal, to a controller external to the transport network device, a request that the controller establish within the packet switched network at least one pseudowire (PW) accessible to the transport network device at the packet network interface and that extends between the first node of the packet switched network and at least one destination node of the packet switched network; and
map transport network data received at the first interface into the at least one pseudowire (PW).
